(19) United States
(12) Patent Application Publication
(10) Pub. No.: US 2008/0240849 A1
(43) Pub. Date: Oct. 2, 2008

(54) Non-marring shaft collar

(76) Inventor: Robert Lindemann, St. James, NY (US)

Correspondence Address: Hoffman, Wasson & Gitler, P.C., Suite 522, 2461 South Clark Street, Arlington, VA, 22202, US

(21) Appl. No.: 11/730,240

(22) Filed: Mar. 30, 2007

(51) Int. Cl. F16B 7/08

(52) U.S. Cl. 403/261

(57) ABSTRACT

A shaft collar including a body with a centrally located bore fits over an elongated shaft. An aperture extends laterally across the body in the vicinity of the bore. The aperture extends laterally into the body also, leaving an arcuate segment situated, radially, between the bore and the aperture. A set screw is advanced radially inwardly through the apertures to press against the arcuate segment and deflect same into engagement with the outer diameter of the elongated shaft. The aperture may possess an elliptical cross-section, an arcuate cross-section, or may assume a circular cross-section. The shaft collar can be made from metal or plastic since the tightening process is performed with zero relative motion between the collar and shaft, and therefore there will be no marring or scratching of the shaft.

### BACKGROUND OF THE INVENTION

The present invention relates to a shaft collar, and similar mechanical components, that are secured snugly around a shaft in a slip-free manner, without marring the surface of the shaft.

Known shaft collars, and similar mechanical components, such as gears, pulleys, hex nuts, handles, and the like, usually include a cylindrical body with a centrally located bore; the bore fits over the outer diameter, or periphery, of an elongated cylindrical shaft. The shaft collar is secured to the shaft by tightening radially spaced set screws. The inner end or tip of each screw presses against the outer diameter of the shaft, and retains the collar in fixed position upon the shaft.

Such known shaft collars, however, have caused burrs or marring, of the shaft, so that the shaft can not be used indefinitely, and must be replaced, periodically, leading to increased maintenance costs, delays or failures in system operation. Additionally, known shaft collars have proven to be unreliable during high torque operations, for the tips of the set screws gouge the metal shaft, in a point-to-point manner and slip thereabout.

In response to the known problems of marring of shafts, and/or slippage of the shaft collar in high torque applications, diverse improved shaft collars have been proposed. The improved shaft collars rely upon relatively broad contact areas in the shaft collar to more efficiently distribute the forces applied by the set screws.

To illustrate, U.S. Pat. No. 3,463,520, Turro, discloses a combination collar-clamp and shaft coupling (20) which clamps around shaft (30) without creating a burr or disfigurement on the shaft. A split clamping ring (38) is retained in recess (36) in the body of the collar clamp, as shown in FIG. 1, and is actuated by one, or more, radially extending set screws (44). The set screws press the inner diameter of the clamping ring, which may be made of spring steel, against the outer diameter of the shaft, and secure the elements together.

U.S. Pat. No. 3,740,085, Evans, discloses a set collar (1) adapted to be mounted on a shaft. The collar includes a radially disposed set screw (3) which presses a plate-like insert (4) against the outer diameter of a shaft. More than one set screw may be employed, as shown in FIG. 3, and the insert (4a) may be a ring with its ends (12, 13) spaced apart a small distance, as shown in FIG. 2, or it may assume the form of a cantilevered plate (4b) as shown in FIG. 4.

Although the holding strength of the clamps disclosed by Turro and Evans represented an advance over prior shaft collars, and marring of the shaft may be reduced, the cost and inconvenience of properly locating a metallic spring insert within the body of the collar introduced additional cost and complexity into the manufacturing and assembly process.

### SUMMARY OF THE INVENTION

Consequently, with the deficiencies of known shaft collars clearly in mind, the present invention pertains to an inexpensive, yet reliable, shaft collar, with increased gripping ability, that does not burr, mar, gouge, or otherwise harm or degrade, the surface of the shaft to which the collar is clamped. The increased gripping ability is sufficient to avoid relative motion between the collar and the shaft, even under high torque conditions.

Furthermore, applicant's shaft collar relies upon a slot, in the body of the collar, to receive a set screw. The radially oriented set screw is advanced inwardly to press against the lower wall of the slot; the wall flexes and presses an arcuate segment defined in the body of the coupling against the outer surface of the shaft. The set screw does not contact the shaft, and the force of the set screw is distributed over a broad contact area, which does not burr, mar, or gouge the shaft.

The slot may assume the form of a straight or elliptical slot, an arcuate slot, or a round hole. The lower, or inner, wall of the slot is spaced from the surface of the shaft by a narrow arcuate segment of material which may be metallic or molded plastic. The amount of flexure of each segment is controlled by the radially inward advance of each set screw.

The narrow arcuate segment of resilient material is bowed or flexed radially inwardly, within its elastic limit. The resilient material may be flexed several times, thus insuring a long operational life, and successful operation, over an extended period of time, for the shaft collar.

Additionally, applicant's shaft collar is simple and relatively inexpensive to manufacture and/or mold, contains a minimum number of components, is relatively light in weight, and can function satisfactorily over a wide range of operating speeds.

Other advantages realized by applicant's shaft collar, vis-à-vis known shaft collars, will become readily apparent to the skilled artisan when the appended drawings are construed in harmony with the ensuing specification. As noted previously, the principles that applicant has applied to the novel shaft collar, find ready application to gears, gear and hub units, pulleys, hexagonal nuts, handles, etc.

### BRIEF DESCRIPTION OF THE DRAWINGS

FIG. 1 is a perspective view of a preferred embodiment of a shaft collar, constructed in accordance with the principles of applicant's invention, seated upon a shaft, the shaft collar possessing a horizontal slot;

FIG. 2 is a perspective view of a first alternative embodiment of applicant's shaft collar seated upon a shaft, the shaft collar possessing an arcuate slot;

FIG. 3 is a perspective view of a second alternative embodiment of applicant's shaft collar seated upon a shaft, the shaft collar possessing a round hole;

FIG. 4A is a vertical cross-sectional view through the shaft collar of FIG. 1 seated upon a shaft;

FIG. 4B is a side view of the shaft collar of FIG. 4A.

FIG. 5A is a vertical cross-sectional view of a gear seated upon a shaft, the gear possessing a slot, with a set screw passing through the slot;

FIG. 5B is a vertical cross-sectional view of a timing pulley seated upon a shaft, the pulley possessing a slot and a set screw passing through the slot.

FIG. 6A is a vertical cross-sectional view of an integrally formed gear and hub seated upon a shaft, the hub possessing a slot, a screw operatively associated with the slot, and a radial undercut which intersects the slot;

FIG. 6B is an end view of a fragment of the gear and hub of FIG. 6A, such view showing the arcuate shape of the slot, and the intersection between a radial undercut and the slot.

FIG. 7A is a vertical cross-sectional view of a hexagonal locking nut seated upon a shaft, the nut possessing a slot with a screw passing therethrough.

FIG. 8 is an elevational view of a relatively large, annular mechanical component seated upon a shaft, with round holes spaced about the component, and a screw passing through each hole for securing the component to the shaft;

FIG. 9A is a vertical cross-sectional view of a shaft collar secured to a shaft, the shaft collar possessing a slot with a screw positioned therein, and a handle projecting vertically from the shaft collar; and

FIG. 9B is an end view of the shaft collar and shaft of FIG. 9A.

### DETAILED DESCRIPTION

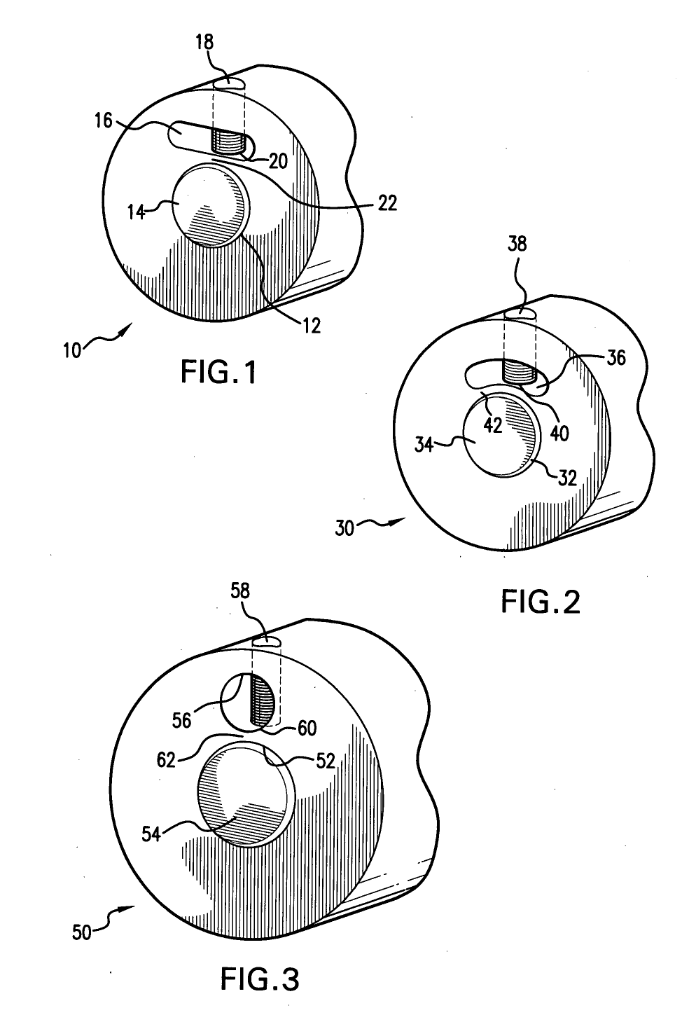

FIG. 1 depicts the preferred embodiment of applicant's invention comprising a cylindrical collar 10 with a central bore 12 that fits over the exterior diameter of cylindrical shaft 14. A horizontally extending slot 16, of elliptical shape, is formed in the body of collar 10, and set screw 18 is operatively associated with slot 16.

Set screw 18 is advanced, in the radial direction, through slot 16. The inner tip 20 of set screw 18 contacts the wall defining the base of slot 16, and exerts an inwardly, radially directed force thereupon. The base deflects and presses arcuate segment 22 against the outer diameter of shaft 14 to lock collar 10 in fixed position on the shaft. The collar remains in locked position, until set screw 18 is withdrawn from contact with the base of slot 16. Set screw 18, made of metal, does not contact shaft 14, and arcuate segment 22 is deflected, within its elastic limit, so that the collar may be used repeatedly, without loss of effective holding power.

FIG. 2 depicts a first alternative embodiment of applicant's invention comprising a cylindrical collar 30 with a central bore 32 that fits over the exterior diameter of cylindrical shaft 34. An arcuate slot 36 is formed in the body of collar 30, and set screw 38 is operatively associated with slot 36.

Set screw 38 is advanced, in the radial direction, through slot 36. The inner tip 40 of set screw 38 contacts the wall defining the base of slot 36, and exerts an inwardly, radially directed force thereupon. The base deflects and presses arcuate segment 42 against the outer diameter of shaft 34 to lock collar 30 in fixed position on the shaft. Collar 30 remains in locked position, until set screw 38 is withdrawn from contact of the base of slot 36. Set screw 38, made of metal, does not contact shaft 34, and arcuate segment 42 is deflected, within its elastic limit, so that the collar may be used repeatedly, without loss of effective holding power.

FIG. 3 depicts a second alternative embodiment of applicant's invention comprising a cylindrical collar 50 with a central bore 52 that fits over the exterior diameter of a cylindrical shaft 54. A round aperture 56 is formed in the body of collar 50, and set screw 58 is operatively associated with aperture 56.

Set screw 58 is advanced, in the radial direction, through aperture 56. The inner tip, or base, 60 of set screw 58 contacts the wall defining the base of aperture 56, and exerts an inwardly, radially force thereupon. The base deflects and presses arcuate segment 62 against the outer surface of shaft 54 to lock collar 50 in fixed position on the shaft. Collar 50 remains in locked position, until set screw 58 is withdrawn from contact with the base of the aperture.

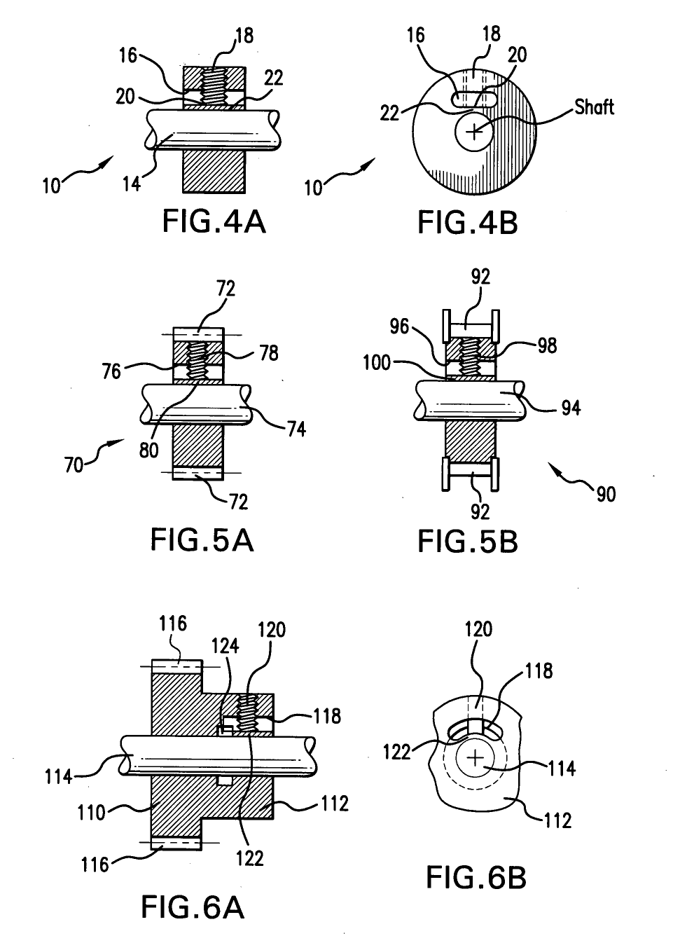

FIGS. 4A-4B provide details of collar 10 shown in FIG. 1. The axial lengths of slot 16 and segment 22 are visible in FIG. 4A, as is the broad contact area between segment 22 and shaft 14. The spatial relationship between set screw 18, slot 16, and segment 22 is shown in FIG. 4B.

FIG. 5A is a vertical cross-sectional view of gear 70, with radially extending teeth 72, secured to shaft 74. Slot 76 extends longitudinally through gear 70, and set screw 78 is advanced radially inwardly through slot 76 to press against the lower wall, or base, of slot 76 and thereby deflect segment 80 against the outer diameter of shaft 74.

FIG. 5B is a vertical cross-sectional view of timing pulley 90, with radially extending teeth 92, secured to shaft 94. Slot 96 extends longitudinally through pulley 90, and set screw 98 is advanced radially inwardly through slot 96 to press against the lower wall, or base, of slot 96 and thereby deflect segment 100 against the outer diameter of shaft 94.

FIG. 6A is a vertical cross-sectional view of gear 110 with hub 112 secured upon shaft 114. Teeth 116 are distributed about the periphery of the gear. The gear and hub are fabricated as an integral mechanical component.

Slot 118 extends along the longitudinal, or axial, extent of hub 112. Set screw 120 is advanced radially through slot 118 to press against the lower wall, or base, of slot 118 and thereby deflects segment 122 against the outer diameter of shaft 114. Radial undercut 124 intersects slot 118 to increase the flexibility of segment 122.

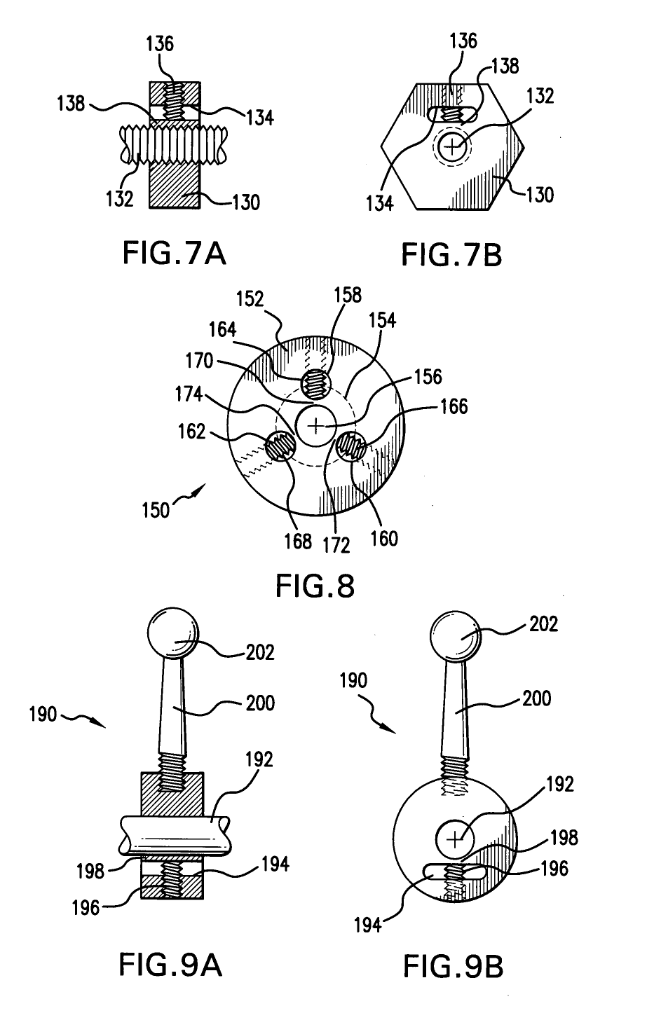

FIG. 7A is a vertical cross-sectional view of nut 130 secured upon threaded shaft 132. Slot 134 extends longitudinally, or axially, through the body of nut 130, and set screw 136 is advanced radially through slot 134. When the lower end, or tip 138, of set screw 136 contacts, and presses forcefully, upon the lower wall, or base, of slot 134, segment 138 is deflected radially inwardly into engagement with the periphery of shaft 132. The shaft may be threaded, and teeth may be formed on the underside of segment 138 to firmly engage same.

As shown in FIG. 7B, nut 130 may be hexagonal in shape, so that the nut may be advanced onto shaft 132 by manual operation, or by a wrench or other torque applying tool (not shown). Slot 134 is elliptical in shape, and its major axis extends in the horizontal direction.

FIG. 8 depicts a large mechanical component 150, such as gear 152 and hub 154, secured to shaft 156. Slots or apertures 158, 160 and 162 are distributed about gear 152 and hub 154, and set screws 164, 166 and 168 project radially inwardly through round apertures 158, 160 and 162. When the set screws are advanced radially inwardly to contact the bases of apertures 158, 160 and 162, segments 170, 172 and 174 are deflected inwardly to press against the outer diameter of shaft 152. The forces securing component 150 to shaft 156 are distributed around the shaft and provide increased gripping power that resists slippage, when under high torque conditions.

FIGS. 9A and 9B show collar 190 secured to shaft 192. Collar 190 comprises a cylindrical body with slot 194 extending axially therethrough. Set screw 196 is advanced radially inwardly until contacting the inner wall of slot 194. The pressure exerted by the tip of set screw 196 on the inner wall of the slot deflects segment 198 into contact with the outer diameter of shaft 192, and locks collar 190 and shaft 192 together. Radially extending handle 200 projects from collar 190, and ball grip 202 is provided at the end of handle 200 remote from collar 190.

Numerous revisions and modifications to the several embodiments of applicant's shaft collar may occur to the skilled artisan. The shape of the collar, as well as the shape of the aperture, such as elliptical, round, or arcuate, may be varied, and the axial extent of each aperture may also be modified, without departing from the scope of applicant's invention. The forming of the aperture in the shaft collars may be achieved by molding same, or by machining same, or some combination of both techniques. Accordingly, the appended claims should be broadly interpreted in a manner consistent with applicant's contribution to the useful arts and sciences, and should not be limited to their literal terms.

I claim:

1. A mechanical component for securement to an elongated shaft, said component comprising:
a) a body with a centrally located bore extending longitudinally through said body,
b) the inner diameter of the bore being slightly greater than the outer diameter of the shaft,
c) an aperture extending laterally across said body in the vicinity of said bore and extending longitudinally into the interior of said body,
d) a segment of said body being located between said aperture and said centrally located bore in said body,
e) a set screw extending radially through said body and intersecting said aperture,
f) said set screw being advanced radially through said aperture to exert a force upon said segment that causes said segment to deflect inwardly over a broad area and press against the outer diameter of the shaft,
g) whereby the shaft collar is locked into fixed position upon the shaft without scratching or abrading same.

2. A mechanical component as defined in claim 1, wherein said aperture is an elliptical slot extending horizontally across said body.

3. A mechanical component as defined in claim 1, wherein said aperture is an arcuate slot extending across said body.

4. A mechanical component as defined in claim 1, wherein said aperture is a circular hole.

5. A mechanical component as defined in claim 1, wherein said body is cylindrical in shape and extends longitudinally in a plane parallel to the shaft.

6. A mechanical component as defined in claim 1, wherein said component comprises an integrally formed gear and a smaller hub, said aperture extending longitudinally into said hub, and a radial undercut defined in said hub, said undercut intersecting said aperture to impact flexibility to said segment.

7. A mechanical component as defined in claim 6, wherein a plurality of apertures are distributed at spaced intervals about said hub, a set screw is operatively associated with each aperture, each set screw pressing against the lower wall of the aperture to deflect an arcuate segment of said hub into engagement with the outer diameter of the elongated shaft.

8. A mechanical component as defined in claim 1, wherein said body is circular in end elevation.

9. A mechanical component as defined in claim 1, wherein said body is hexagonal in end elevation.

10. A mechanical component as defined in claim 1, further including a handle with a threaded end, said threaded end being secured to said collar in a radial direction, so that said handle can be manipulated to apply a rotative force to said collar.
